(19) United States
(12) Patent Application Publication
(10) Pub. No.: US 2010/0030686 A1
(43) Pub. Date: Feb. 4, 2010

(54) RETIREMENT PAYCHECK APPARATUS AND METHODS

(75) Inventors: David T. Lee, Charlotte, NC (US); Carrie A. Williams, Alpharetta, GA (US)

Correspondence Address: Weiss & Arons, LLP, 1540 Route 202, Suite 8, Pomona, NY, 10970, US

(73) Assignee: Bank of America Corp., Charlotte, NC (US)

(21) Appl. No.: 12/196,411

(22) Filed: Aug. 22, 2008

Related U.S. Application Data
(60) Provisional application No. 61/085,468, filed on Aug. 1, 2008.

(51) Int. Cl. G06Q 40/00

(52) U.S. Cl. 705/39

(57) ABSTRACT

Apparatus and methods for providing funds to a bank customer. A bank customer may have a retail bank account in the custody of a bank. The bank may provide retail banking services to the bank customer in connection with the retail bank account. After providing the retail banking service, the bank may electronically link a retirement fund management module to the bank account. The retirement fund management module may be configured to transfer a predetermined amount of retirement funds into the bank account. The transfer may be made in accordance with rules. The rules may be selected by the bank customer.

### CROSS-REFERENCE TO RELATED APPLICATIONS

This is a nonprovisional application of U.S. Application No. 61/085,468, filed on Aug. 1, 2008, which is hereby incorporated herein in its entirety.

### FIELD OF TECHNOLOGY

Aspects of the disclosure relate to retirement planning, retirement fund distribution and/or cash flow management. In particular, the disclosure relates to banking services that support retirement planning and fund distribution.

### BACKGROUND

Individuals typically use multiple funding sources to provide retirement income. The sources include tax-deferred investments, securities and cash savings, among other things. the sources may have different amounts of funds, be available to be drawn at different times, generate income at different rates and at different times and have different tax consequences.

Individuals who plan for retirement often have difficulty knowing how to deposit funds in the sources in a manner that will maximize the value and effectiveness of the funds when the time comes to draw from them. Also, when the time comes to draw from the funds, it can be difficult for retirees to know how to draw the funds in a manner that preserves capital and future earnings while at the same time covers present living expenses.

It therefore would be desirable to provide apparatus and methods for effectively funding retirement assets.

It therefore also would be desirable to provide apparatus and methods for drawing from retirement assets in a manner that provides cash for living expenses.

### SUMMARY OF EMBODIMENTS

It is an object of this invention to provide apparatus and methods for effectively managing retirement cash flow.

It is another object of this invention to provide apparatus and methods for drawing from retirement assets in a manner that provides cash for living expenses.

It is yet another object of this invention to provide apparatus and methods for simulating paycheck-based income during retirement.

Apparatus and methods for providing funds to a bank customer, therefore, are provided. The apparatus and methods may involve providing retail banking service to the bank customer. The bank customer may have a bank account in the custody of the bank. After providing the retail banking service, the bank may electronically link a retirement fund management module to the bank account. The retirement fund management module may be configured to transfer a predetermined amount of retirement funds into the bank account. The transfer may be made in accordance with rules. The rules may be selected by the bank customer.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative system in accordance with the principles of the invention;

FIG. 2 shows illustrative apparatus that may be used in accordance with the principles of the invention; and

FIG. 3 shows steps of an illustrative process in accordance with the principles of the invention.

### DETAILED DESCRIPTION OF EMBODIMENTS

It is estimated that only 1 of 3 retirees with household assets of between $100,000 and $249,000 have calculated how long the assets will last during retirement. Over 70% of retirees have not created plans to convert assets into income. Some embodiments of the invention may provide bank customers with an income stream during retirement. The income stream may be programmed in advance. The income stream may include a user definable payout. The bank customer may select the payout amount, schedule, sources and any other suitable attributes. The amount and scheduling of the income, therefore, may be predictable. By providing such convenience and predictability to the bank customers, customers may be encouraged to increase the amount of funds that they deposit in the bank account and the retirement fund sources.

Apparatus and methods for providing funds to a bank customer are provided. The apparatus and methods may involve providing a retail bank account, or providing retail banking services for such an account, and electronically linking a retirement fund distribution module to the retail bank account. The retail bank account may have an account number that does not change after the account is linked to the retirement fund distribution module. The retirement fund distribution module may receive funds from retirement fund sources and transfer some or all of the funds, or earnings therefrom, to the retail banking account as a “paycheck” or “retirement paycheck.” The retirement fund sources may include any suitable retirement funds, investment vehicles, savings and the like. The earnings from the retirement fund sources may include, interest, dividends, earnings from sales of stock or other securities and any other suitable earnings.

The retirement fund distribution module may be used to transfer the retirement paycheck amount into the bank account. The retirement fund distribution module may draw from one or more retirement fund sources funds that are, in aggregate, equal to the retirement paycheck amount. A fee may be collected from the bank customer for drawing the funds from the one or more retirement fund sources and transferring the retirement paycheck into the bank account.

In some embodiments, the retirement fund module may transfer money from the bank account into one or more of the retirement fund sources. For example, an insurance policy, such as a life insurance policy, may be considered a retirement fund source. The retirement fund module may transfer money from the bank account into the insurance policy. This may include the payment or partial payment of a premium. The payment may be made on a schedule by the retirement fund module.

Some embodiments may involve providing a holding account for holding some or all of the predetermined amount prior to transferring the predetermined amount into the bank account. The holding account may be referred to herein as a “paycheck account.”

Retirement fund sources may become unable to provide sufficient funds to pay out a planned retirement paycheck amount. The retirement fund sources may be able to pay out only a reduced paycheck amount. In some embodiments, the bank customer may elect retirement paycheck insurance. Retirement paycheck insurance insures the uniformity of retirement paychecks over a period of time. The bank customer may pay a premium for the insurance. Based on the insurance, the bank, or another institution, may pay the bank customer an amount corresponding to the deficiency of the reduced paycheck relative to the planned paycheck. The payment may be made into the customer's bank account immediately after it is determined that the retirement fund sources are unable to provide sufficient funds for the planned paycheck amount. The bank customer, therefore, can continue with normal banking activities without the risk of overdraft because of insufficient retirement funds.

In some embodiments, the bank may respond to an insufficiency of retirement funds by lending money to the bank customer. Those embodiments may include a paycheck “flattening” program in which the customer may enroll. In such a program, the bank customer may agree to lending terms that would apply if the bank pays the bank customer an amount to compensate for insufficient retirement funds. The bank customer and the bank may agree on the lending terms prior to an insufficiency of retirement funds. In the event of an insufficiency, therefore, the bank may automatically lend funds to the bank customer so that the planned retirement paycheck amount will be transferred into the customer's bank account. The bank customer, therefore, can continue with normal banking activities without the risk of overdraft because of insufficient retirement funds.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

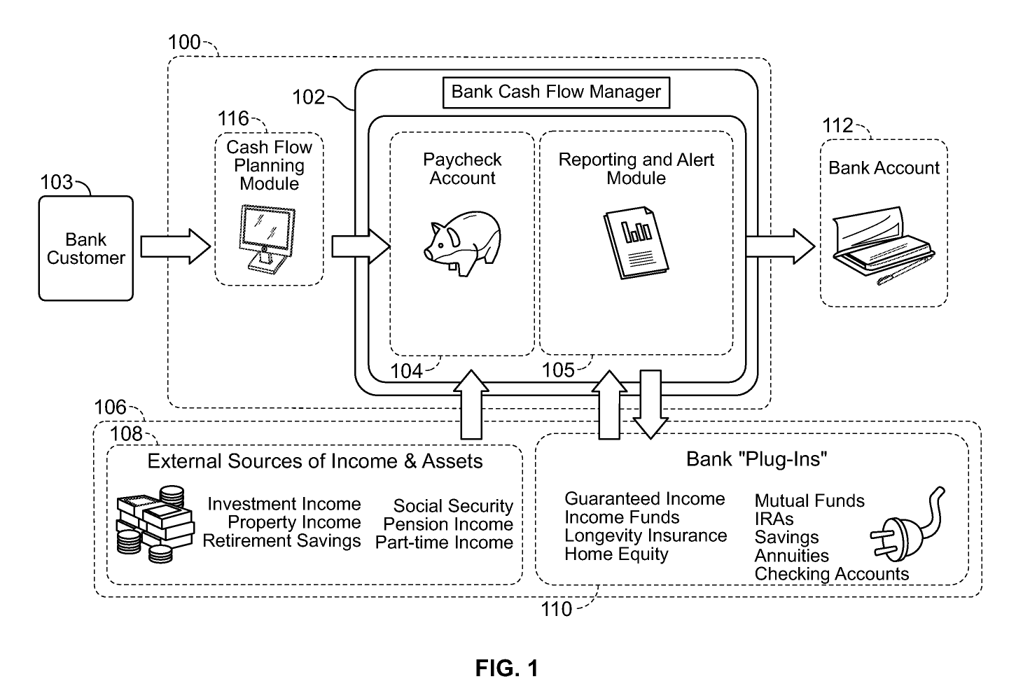

FIG. 1 shows illustrative system 100 for providing funds to a bank customer. System 100 may include bank cash flow manager 102. Bank cash flow manager 102 may be implemented as a retirement fund distribution module. Bank cash flow manager 102 may include paycheck account 104 and reporting and alert module 105. Paycheck account 104 may receive funds from, or invest funds in, one or more retirement fund sources 106. Retirement fund sources 106 may include external sources of income and assets 108. “External” sources include sources that are in the custody of a financial institution other than the bank that administers bank cash flow manager 102. Retirement fund sources 106 may include bank plug-ins 110. Bank plug-ins 110 include sources that are in the custody of the bank that administers bank cash flow manager 102. Bank plug-ins 110 are examples of “internal” sources.

In some embodiments, paycheck account 104 may receive funds from, or invest funds in, one or more non-retirement fund sources (not shown). Non-retirement fund sources may include real estate, business ventures, licensing and other suitable fund sources.

External sources of income and assets 108 may include income from investments, property, social security, pension, wages and any other suitable sources of income. External sources of income and assets 108 may include assets such as retirement savings. Bank plug-ins 110 may include one or more of the following bank products: guaranteed income, income funds, longevity insurance, home equity, mutual funds, IRAs, savings, checking accounts, annuities and any other suitable bank and/or investment products. It will be appreciated that different banks offer different investment products. Therefore, a bank product that is considered a bank plug-in by one bank may be considered an external source of income and assets by another bank.

Paycheck account 104 may hold funds that bank cash flow manager 102 receives from retirement fund sources 106. Bank cash flow manager 102 may transmit some or all of the funds in paycheck account 104 to bank account 112. Bank account 112 may be controlled by bank customer 103. In some embodiments, bank account 112 may be used by bank customer 103 as a retail bank account that is not linked to bank cash flow manager 102. Bank cash flow manager 102 may then be electronically linked via internal banking link 114 to bank account 112. Bank customer 103 may thus receive the benefit of bank cash flow manager 102 without the effort and/or expense that might be required to engage a third party service to manage funds.

Reporting and alert module 105 may provide bank customer 103 with information regarding sources of funds, use of funds, assets, budgeting and any other suitable information.

Bank customer 103 may provide instructions to cash flow manager 102 regarding the flow of cash between retirement fund sources 106, paycheck account 104 and bank account 112. The instructions may include any suitable instructions. For example, the instructions may require that a selected total amount of funds from retirement fund sources 106 be moved to bank account 112. The movement of funds may be required to occur on a schedule. The schedule may be a periodic, or regular, schedule.

The instructions may require that a fixed regular amount of funds be transferred into bank account 112 on a fixed schedule. The funds may be derived from any of retirement fund sources 108 and/or any other account linked to paycheck account 104. This may replicate the experience of receiving a steady paycheck.

Because, in some embodiments, bank account 112 is an established account in the custody of the bank, the bank may have direct access to the historical banking activity. In such embodiments, cash flow planning module 116 may use information based on the historical activity to assist a bank customer in determining an appropriate retirement paycheck amount to transfer from paycheck account 104 into bank account 112. The determination of the amount may be based at least in part upon the historical information, the bank customer's preferences and/or any other suitable factors.

The instructions may require that the fixed regular amount of funds be adjusted from time to time, or at one or more selected times of year, to compensate for changes in the cost of living. The instructions may require that an additional amount of funds be transferred during a holiday season. This may replicate the experience of receiving a bonus. In some embodiments, the instructions may require that funds be transferred quarterly or at some other suitable time interval.

In some embodiments, the instructions may include rules that identify amounts of funds to be moved from each of one or more of retirement fund sources 106. In some embodiments, the rules may identify for one or more of retirement fund sources 106 a proportion of a total fund transfer that should be drawn from the retirement fund source. The rules may be applied so as to maximize the economic efficiency of fund transfer, minimize tax consequences, maximize retirement fund earnings or for any other suitable purpose.

The instructions may require that funds from retirement fund sources 106 be used to maintain a substantially steady balance in bank account 112. The instructions may provide rules for holding funds in paycheck account 104. For example, the instructions may require that cash reserves in paycheck account 104, or in any other suitable cash account, be maintained at a selected value.

In some embodiments, the instructions may provide rules for moving funds from paycheck account 104 into one or more of retirement fund sources 106. For example, the rules may require that an insurance policy premium be paid or partially paid using funds from paycheck account 104. Such payments may be made on a schedule by the retirement fund module. The insurance policy may be, for example, a life insurance policy.

In some instances, two spouses may jointly own paycheck account 104. A life insurance policy on one of the spouses may be linked to paycheck account 104. A benefit from the life insurance policy may be paid to the surviving spouse through paycheck account 104. The instructions may provide rules for distributing the benefit. For example, the rules may require that some or all of the benefit be held in paycheck 104. The rules may require that some or all of the benefit may be transferred to one or more of retirement fund sources 106, to other accounts that are linked to paycheck account 104 or to one or more individuals.

Payments from the paycheck account may be made to any account that is linked to paycheck account 104. Retirement fund sources 106 may be linked accounts. Other accounts also may be linked accounts. For example, automobile lease, telephone and utility accounts, information entertainment media subscriptions and the like may be linked accounts. Because the payments may be set up for recurrence, little or no subsequent involvement on behalf of the paycheck account owner may be required.

Some embodiments may include cash flow planning module 116. Bank customer 103 may use cash flow planning module 116 to program instructions for cash flow manager 102. Cash flow planning module 116 may include software for calculating amounts of money to be invested in one or more of retirement fund sources 106. In some embodiments, cash flow planning module 116 may provide to bank customer 103 a planning recommendation that is based on records of historical activity in bank account 112, the bank customer's preferences or any other suitable information.

In some embodiments, cash flow planning module 116 may provide bank customer 103 with one or more projections of cash flow for a retirement period or a hypothetical retirement period. The projections may be based on any suitable assumptions about funds available, rates of return-on-investment, starting date of retirement, length of retirement period, and any other suitable factors. In some embodiments, cash flow planning module 116 may include a computer user interface that has a “Retire Now” button. Pushing the Retire Now button may provide bank customer 103 with retirement paycheck values based on commencement, or hypothetical commencement, of retirement when the button was pushed or on a suitably contemporary date.

Tables 1-4 list illustrative features that may be provided by a bank cash flow manager such as bank cash flow manager 102 or portions thereof. Table 1 lists illustrative cash-holding features. Table 2 lists illustrative cash inflow features. Table 3 lists illustrative cash outflow features. Table 4 lists illustrative reporting features.

TABLE 1
Illustrative cash-holding features
Illustrative cash-holding features

Sweep idle money into a bank account
Sweep idle money into an investment account
Sweep idle money into a mutual fund
Sweep idle money from a bank account into a retirement
fund source
Provide a sweep account (e.g., with compelling interest)
Keep a selected amount of cash on hand (e.g., with 2-12
months of liquidity)
Provide tiered interest (higher rates for higher balances)

TABLE 2
Illustrative cash-inflow features
Illustrative cash-inflow features

Allow inflow from in-bank accounts
Allow inflow from external accounts
Pull (as opposed to merely receive) funds from linked
accounts
Allow customer to set order of liquidation of fund sources
Liquidate assets in tax-efficient order
Allow direct deposit from social security, pension,
Required Minimum Distributions (RMDs)from internal or
external sources
Provide overdraft protection
Tie to credit lines

TABLE 3
Illustrative cash-outflow features
Illustrative cash-outflow features

Set distribution dollar amount
Set timing of distribution (e.g., monthly, bimonthly,
weekly)
Allow outflow to one or more internal bank accounts
Automate billpay from paycheck account
Allow outflow to investment accounts
Allow bank customer to set preferences for distribution of
excess funds
Allow customer to change “paycheck” amount
Allow customer to change “paycheck” amount at any time
Allow customer to make one-time change of “paycheck”
amount
Allow customer to make seasonal changes of “paycheck”
amount

TABLE 4
Illustrative reporting features
Illustrative reporting features

Monthly statements showing planned and actual spending in
a bank account such as a checking account
Automated transaction machine (“ATM”) access to a paycheck
account
Online banking service for paycheck account
Account statement showing activity and balances in related
bank accounts
Reporting of plug-in activity and balances
Portal that allows access to related bank accounts
Report comparison of checking account with outflows from
paycheck account (and make recommendations for changes)
Show allocation of sources of income (e.g., pie chart
showing 40% from social security, 40% from dividends and
20% from savings)
Show historical rate of inflows and outflows from one or
more accounts

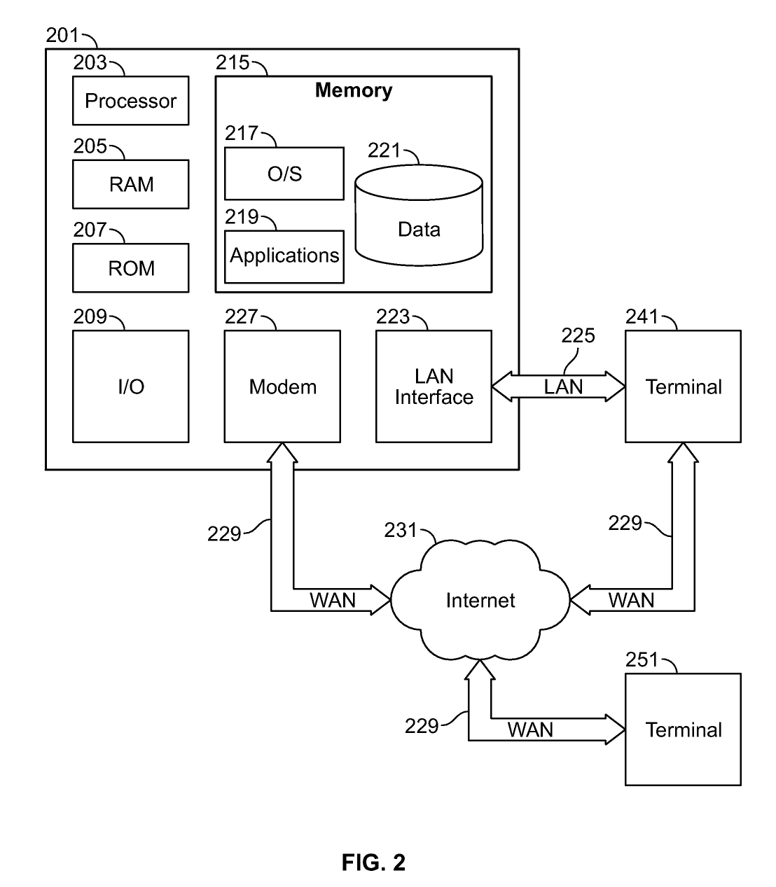

FIG. 2 shows a block diagram of an illustrative generic computing device 201 (alternatively referred to herein as a “server”) that may be used in accordance with the principles of the invention. Server 201 may have processor for controlling overall operation of server 201 and its associated components, including RAM 205, ROM 207, input/output module 209, and memory 225.

Input/output (“I/O”) module 209 may include a microphone, keypad, touch screen, and/or stylus through which a user of device 201 may provide input, and may also include one or more of a speaker for providing audio output and a video display device for providing textual, audiovisual and/or graphical output. Software may be stored within memory 225 and/or storage to provide instructions to processor 203 for enabling server 201 to perform various functions. For example, memory 225 may store software used by server 201, such as an operating system 217, application programs 219, and an associated database 221. Alternatively, some or all of server 201 computer executable instructions may be embodied in hardware or firmware (not shown). Database 221 may provide storage for bank customer instructions, account balance information, historical bank customer banking activity records and any other suitable information.

Server 201 may operate in a networked environment supporting connections to one or more remote computers, such as terminals 241 and 251. Terminals 241 and 251 may be personal computers or servers that include many or all of the elements described above relative to server 201. The network connections depicted in FIG. 2 include a local area network (LAN) 225 and a wide area network (WAN) 229, but may also include other networks. When used in a LAN networking environment, computer 201 is connected to LAN 225 through a network interface or adapter 223. When used in a WAN networking environment, server 201 may include modem 227 or other means for establishing communications over WAN 229, such as Internet 231. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 219, which may be used by server 201, may include computer executable instructions for invoking user functionality related to communication, such as email, short message service (SMS), and voice input and speech recognition applications.

Computing device 201 and/or terminals 241 or 251 may also be mobile terminals including various other components, such as a battery, speaker, and antennas (not shown).

A financial institution may use a terminal such as 241 or 251 to administer a bank cash flow manager such as bank cash flow manager 102. A customer such as bank customer 103 may use a terminal such as 241 or 251 to provide instructions to a bank cash flow manager such as bank cash flow manager 102. The customer may use a terminal such as 241 or 251 to receive reports and/or alerts from a reporting and alert module such as 105.

Applications 219 may include applications for administering and/or controlling a bank cash flow manager such as 102. Applications 219 may include applications for electronically linking a cash flow manager such as 102 with an account such as 112 via an electronic link such as 114.

Memory 225 may be used to store data regarding a bank customer such as 103, instructions and rules issued by the bank customer, administrative rules and data for a bank cash flow manager such as 102 and/or balance information for an account such as 104 and 114 and/or one or more of retirement fund sources 106.

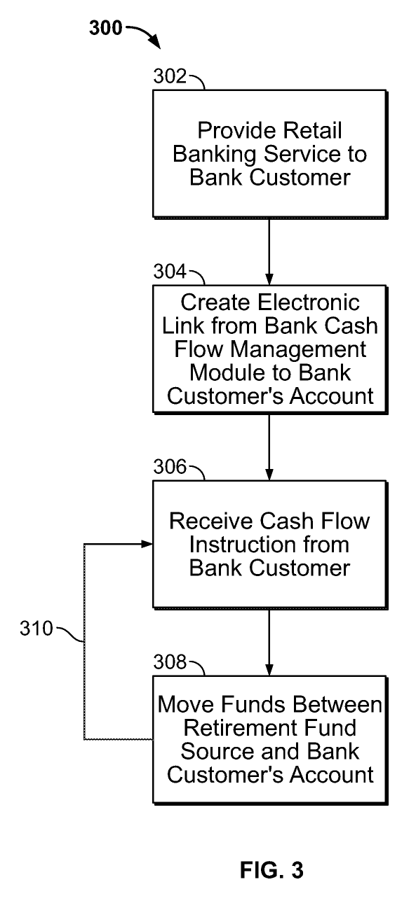

FIG. 3 shows illustrative process 300 for providing funds to a bank customer. The steps of process 300 will be described for the sake of illustration as being executed by a bank. The bank may execute the steps using any suitable system. The system may involve some or all of the apparatus shown in FIG. 2 and/or any other suitable device. In some embodiments, steps of process 302 may be performed at least partially by a human being.

At step 302 of process 300, the bank may provide retail banking service to a bank customer. The retail banking service may include opening a retail bank account, servicing an existing retail bank account, providing and processing payment instruments such as checks and electronic fund transfers, providing periodic statements, providing telephone-actuated reports and fund-related services and the like.

At step 304, the bank may create an electronic link from a bank cash flow management module to the bank customer's bank account. The cash flow management module may have some or all of the features shown and described herein in connection with cash flow management module 102 (see FIG. 1).

At step 306, the bank may receive on or more cash flow instructions from the bank customer. Such a cash flow instruction may include requirements for the transfer of funds between one or more retirement fund sources, such as retirement fund sources 106, and an account such as 104 or 112 (shown in FIG. 1). The instruction may have some or all of the features of the cash flow instructions described above.

At step 308, the bank may move funds between the retirement fund source and an account such as 104 and/or 112. Process 308 may follow path 310 to repeat step 306. When step 306 is repeated, the bank may receive further instructions from the bank customer. It will be appreciated that using the system (see FIG. 1) and apparatus (see FIG. 2) described above, the bank may receive instructions from the bank customer one instruction at a time, in a batch, or in any other suitable mode. It would therefore be unnecessary in some embodiments of the invention for the bank customer to provide further instructions at step 306 after every execution of step 308 by the bank.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention is described herein in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention are described herein in terms of claims thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, apparatus and methods for providing funds to a bank customer have been provided. Persons skilled in the art will appreciate that the present invention can be practiced by other than the described embodiments, which are presented for purposes of illustration rather than of limitation, and that the present invention is limited only by the claims that follow.

What is claimed is:

1. A method for providing funds to a bank customer, the method comprising:
administering a retail bank account for a bank customer; and
electronically linking to the bank account a retirement fund management module that is configured to transfer a predetermined amount of funds into the bank account.

2. The method of claim 1 further comprising using the retirement fund management module to transfer the predetermined amount of funds into the bank account.

3. The method of claim 1 further comprising using the retirement fund management module to (a) receive funds from a fund source; and (b) transfer the predetermined amount of funds into the bank account.

4. The method of claim 3 wherein using the retirement fund management module to transfer the predetermined amount comprises pulling the predetermined amount from the fund source.

5. The method of claim 3 further comprising, when the retirement fund management module includes a paycheck account:
identifying a balance in the paycheck account, the balance resulting at least in part from funds that (a) were received from the fund source and (b) were not transferred to the bank account; and
depositing the balance in a designated account, the designated account having been designated by the bank customer to receive the balance.

6. The method of claim 5 wherein the depositing comprises depositing the balance in a regular bank account.

7. The method of claim 5 wherein the depositing comprises depositing the balance in an investment account.

8. The method of claim 5 wherein the depositing comprises transferring the balance to a retirement fund source.

9. The method of claim 5 wherein the depositing comprises investing the balance in a mutual fund.

10. The method of claim 5 further comprising opening the designated account for the customer.

11. The method of claim 1 further comprising using the retirement fund management module to draw funds from a fund source, wherein the funds drawn from the fund source are equal to the predetermined amount of funds.

12. The method of claim 1 further comprising receiving from the bank customer an instruction to transfer the predetermined amount from a fund source.

13. The method of claim 12 further comprising, when the fund source is one of several fund sources, receiving from the bank customer information setting forth an order of liquidation for the several fund sources.

14. The method of claim 12 wherein the receiving comprises receiving information identifying the amount.

15. The method of claim 12 wherein the receiving comprises receiving information identifying when to transfer the predetermined amount.

16. The method of claim 15 further comprising an instruction to transfer the predetermined amount on a recurring basis.

17. The method of claim 16 further comprising an instruction to transfer a bonus amount of funds into the bank account.

18. The method of claim 1 further comprising receiving from the bank customer an instruction to transfer the predetermined amount.

19. A method for providing retirement funds to a bank customer, the method comprising electronically reconfiguring a bank account at a bank to be a retirement fund management account.

20. A method for providing a regular paycheck to an individual during a retirement period of the individual's life, the method comprising:
administering a bank account on behalf of the individual;
linking to the bank account a retirement fund management module;
receiving from the individual information including a retirement paycheck amount; and,
during the retirement period, providing the paycheck to the individual by transferring funds corresponding to the amount into the bank account.

21. The method of claim 20 further comprising:
linking the retirement fund management module to a fund source; and
receiving the funds corresponding to the paycheck amount from the fund source.

22. The method of claim 21 wherein the receiving comprises pulling the funds corresponding to the paycheck amount from the fund source.

23. The method of claim 22 wherein, when the fund source is one of several funds sources, the receiving comprises receiving a portion of the funds corresponding to the paycheck amount from at least two of the fund sources.

24. The method of claim 23 further comprising, when the retirement fund management module includes a paycheck account:
identifying a balance in the paycheck account, the balance resulting at least in part from retirement funds that (a) were received by the paycheck account and (b) were not transferred to the bank account; and
depositing the balance in a designated account, the designated account having been designated by the bank customer to receive the balance.

25. The method of claim 24 wherein the depositing comprises depositing the balance in a regular bank account.

26. The method of claim 24 wherein the depositing comprises depositing the balance in an investment account.

27. The method of claim 24 wherein the depositing comprises transferring the balance to a fund source.

28. The method of claim 24 wherein the depositing comprises investing the balance in a mutual fund.

29. The method of claim 24 further comprising opening the designated account for the customer.

30. The method of claim 20 further comprising:
receiving from the individual information including a retirement paycheck bonus amount; and,
providing the retirement paycheck bonus to the individual by transferring funds corresponding to the paycheck bonus amount into the bank account.

31. A computer-readable medium storing computer-executable instructions which, when executed by a processor on a computer system, perform a method for providing a regular paycheck to an individual during a retirement period of the individual's life, the method comprising:
performing an administrative task for a bank account on behalf of the individual;
linking to the bank account a retirement fund management module;
receiving from the individual information including a retirement paycheck amount; and,
during the retirement period, providing the paycheck to the individual by transferring funds corresponding to the amount into the bank account.

32. The medium of claim 31 wherein the method further comprises:
linking the retirement fund management module to a fund source; and
receiving the funds corresponding to the paycheck amount from the fund source.

33. The medium of claim 32 wherein the method further comprises receiving comprises pulling the funds corresponding to the paycheck amount from the fund source.

34. The medium of claim 31 wherein the method further comprises:
receiving from the individual information including a retirement paycheck bonus amount; and,
providing the retirement paycheck bonus to the individual by transferring funds corresponding to the paycheck bonus amount into the bank account.
